(19) United States
(12) Patent Application Publication
(10) Pub. No.: US 2008/0000731 A1
(43) Pub. Date: Jan. 3, 2008

(54) Power screw disc brake caliper assembly

(75) Inventors: James T. Dewberry, Greer, SC (US); Charles Alleman, Moore, SC (US); Lee Lipford, Union, SC (US); Benjamin J. Smith, Moore, SC (US); Peter D. Mathern, Greenville, SC (US)

Correspondence Address: THE WEBB LAW FIRM, P.C., 700 KOPPERS BUILDING, 436 SEVENTH AVENUE, PITTSBURGH, PA, 15219, US

(73) Assignee: WABTEC HOLDING CORPORATION

(21) Appl. No.: 11/479,359

(22) Filed: Jun. 30, 2006

(51) Int. Cl. F16D 55/08

(52) U.S. Cl. 188/72.7

(57) ABSTRACT

A disc brake caliper assembly for moving brake pads straddling the brake disc against each side of a brake disc comprises two tongs pivotably supported. The tongs have brake heads and pads at one end and power nut support pins journaled at the other end. The power nuts are pivotally supported from the power nut support pins. A power screw extends between the tongs and has external threaded ends threaded in the power nuts such that rotation of the power screw will force the power nuts apart thus causing the brake pads to engage the brake disc.

### BACKGROUND OF THE INVENTION

1. Field of the Invention

This invention relates to air-operated disc brakes of the type normally used on certain rail vehicles, such as those used on passenger trains.

2. Description of Related Art

Caliper-type disc brakes with pivoted tongs straddling the brake disc have been used for braking of rail vehicles for some time. Examples of prior art caliper-type disc brakes include those disclosed in U.S. Pat. No. 3,148,749 entitled “Rotor Brake” and U.S. Pat. No. 3,986,584 entitled “Fail-Safe Disc Brake with Spring Actuated Slack Adjuster.” These brakes include caliper assemblies with pivoted tongs that embrace the brake disc. The tongs carry brake heads with brake pads fixed thereto. In the referenced patents, the tongs are driven apart at one end by a wedge to squeeze together the brake pads at the other end and into contact with each face of the brake disc.

As with any brake assembly, it is desirable that the response not change as brake pads wear. For this reason, there must be provision for adjusting the amount of slack which needs to be taken up before the pads contact the disc. The slack adjusters used in the prior art described above require a ratchet action between two elements that slide linearly relative to each other.

It is an advantage of the present invention to provide a compact design that makes use of parts that have been developed for automotive disc brakes.

### SUMMARY OF THE INVENTION

Briefly, according to one embodiment of this invention, there is provided a power screw disc brake assembly comprising a frame supporting two spaced and parallel journaled tong pins and two tongs pivotably supported from the frame by respective tong pins. The tongs have brake head pins journaled at one end and power nut support pins journaled at the other end. The tongs are positioned enabling them to straddle a brake disc. Brake heads and pads are pivotally supported from the brake head pins. The pads have a friction face adjacent the brake disc. Power nuts are pivotally supported from the power nut support pins. The power nuts have internal threads, there being right-hand threads in one power nut and left-hand threads in the other power nut. The power nuts are secured so as not to rotate about the axis of the threaded openings therein. A power screw extends between the tongs and has external threaded ends threaded in the power nuts. A lever arm is operatively attached to the power screw for rotating of the power screw. A pneumatic cylinder and piston are positioned between the frame and lever arm for causing rotation of the lever arm and the power screw. A slack adjuster mechanism enables the pneumatic cylinder and piston to return to near the same retracted position as the brake shoes wear. Rotation of the lever arm in one direction will cause a rotation of the power screw to force the power nuts apart, thus causing the brake pads to engage the brake disc.

In a preferred embodiment, the frame may be secured relative to the brake disc by a hinge plate having a hinge pin. The hinge pin is oriented so that the hinge pin can lie in a plane that is embraced by the brake disc and is generally parallel to the friction faces of the brake disc.

In a preferred embodiment, the slack adjuster comprises a worm and worm gear. The worm is journaled in a chamber in the lever arm and the worm gear is secured to the power screw between the threaded ends of the power screw.

### BRIEF DESCRIPTION OF THE DRAWINGS

Further features and other objects and advantages will become apparent from the following detailed description in which:

FIG. 1 is a perspective view of one embodiment of the present invention;

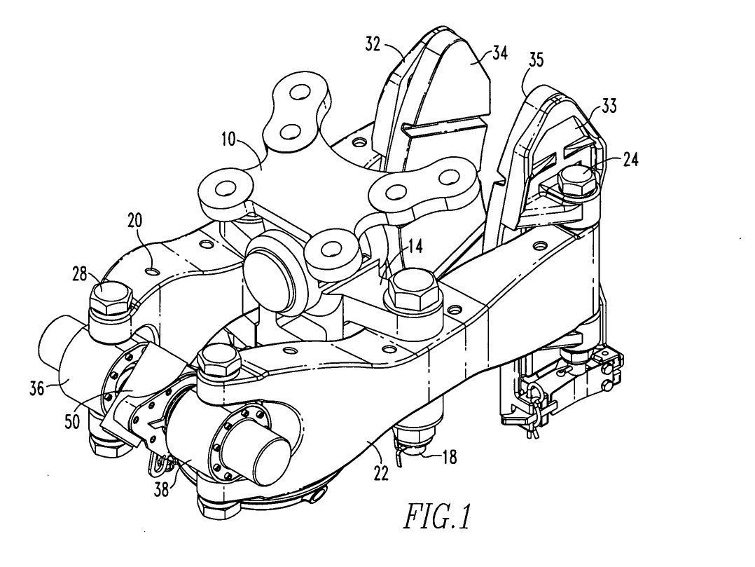

FIG. 2 is a top view of the embodiment of FIG. 1;

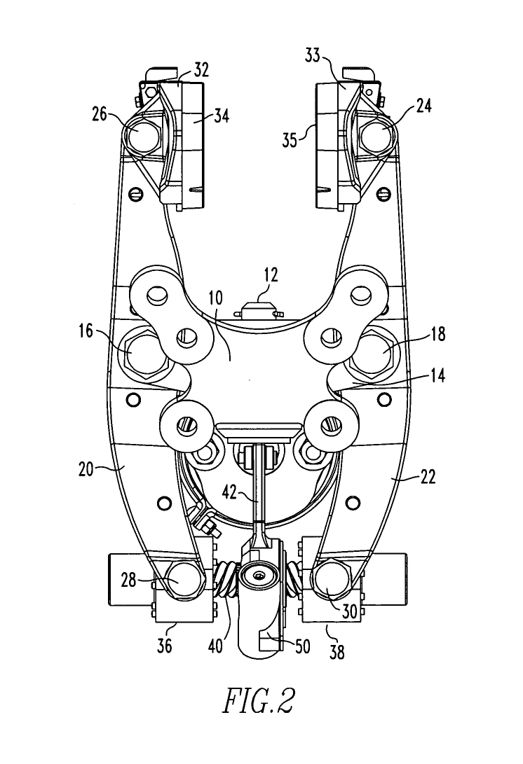

FIG. 3 is a front view of the embodiment of FIG. 1;

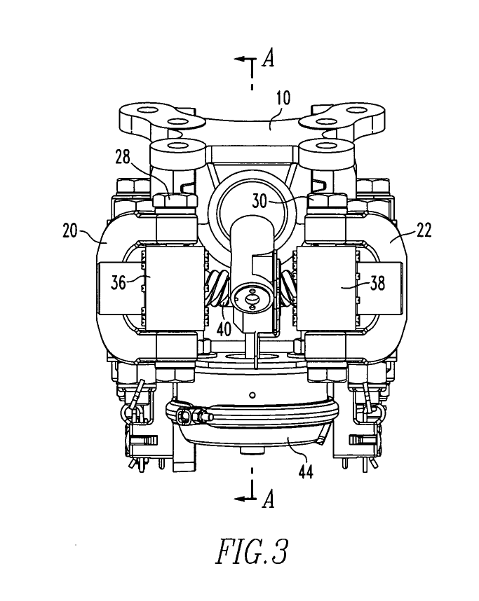

FIG. 4 is a side view of the embodiment of FIG. 1; and

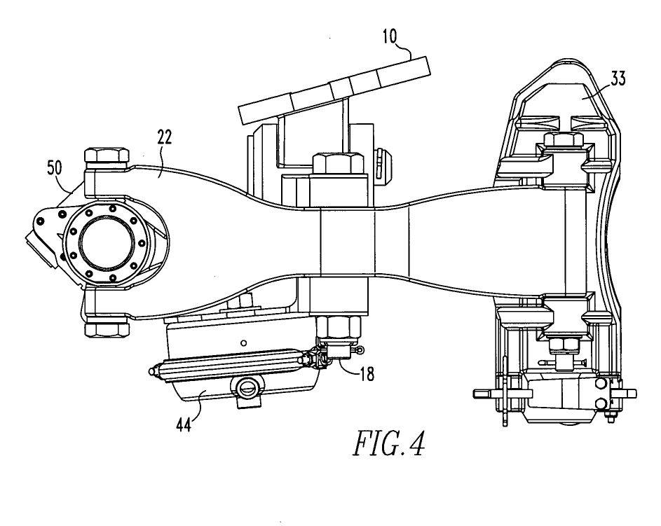

FIG. 5 is section view taken along line A-A of FIG. 3.

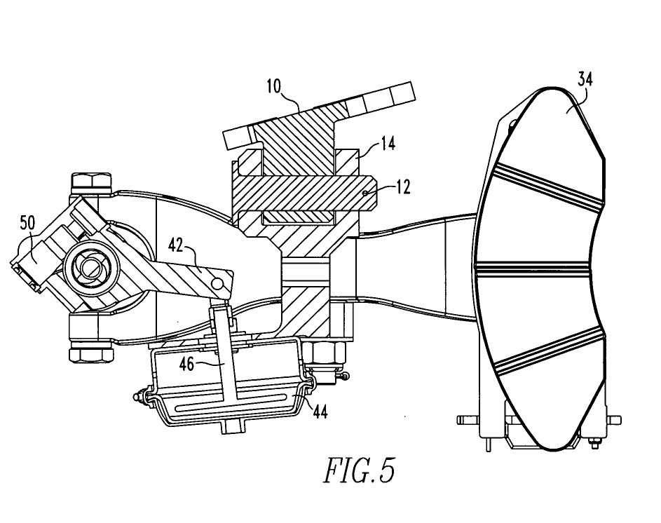

### DESCRIPTION OF THE PREFERRED EMBODIMENTS

On rail vehicles, brake discs are normally fixed relative to the axle of a wheeled vehicle. They may be pressed onto the axle or supported from the wheel. The axle is journaled in a truck supporting the wheels and axle from the vehicle chassis. Normally, the truck comprises side frames spaced apart and supported by a bolster which, in turn, is rotatably attached to the vehicle chassis. The present invention relates to a disc brake caliper assembly for moving brake pads against each side of the brake disc.

Referring now to the drawings, a hinge plate 10 has openings for bolts enabling the hinge plate to be mounted onto a supporting structure, such as the side frames of the truck. The hinge plate 10 has a journaled hinge pin 12 with an axis lying in a plane embraced by the brake disc. In this way, the caliper assembly is generally aligned with edges of the brake disc. A frame 14 is pivotably supported from the hinge plate 10 by the journaled hinge pin 12. Normally, rotation of the frame 14 about the hinge pin is very slight. This movement allows for adjustments needed because of flexing of the axle as it rolls down the track. The frame 14 supports two spaced apart parallel journaled tong pins 16, 18 having axes lying in a plane perpendicular to hinge pin 12. Two tongs 20, 22 are pivotably supported from the frame 14 by respective tong pins. The tongs are generally symmetrical and having brake head pins 24, 26 journaled at one end and power nut support pins 28, 30 journaled in forked extension at the other end.

Brake heads 32, 33 and pads 34, 35 are pivotally supported from the brake pins 24, 26. Brake pads 34, 35 have friction faces for abutting the brake disc.

Power nuts 36, 38 are pivotally supported between the forked extensions by the power nut support pins 28, 30. The power nuts have internal threads; one has right-hand threads and the other has left-hand threads. A power screw 40 extends generally perpendicular to the tongs and has external threaded ends turned into the power nuts. Thus, rotation of the power screw moves the forked ends of the tongs away or together depending on the direction of rotation.

A lever arm 42 is operatively attached to the power screw 40 via slack adjuster mechanism 50 for imparting rotation of the power screw. A pneumatic cylinder 44 and piston 46 are positioned between the frame 14 and lever arm 42 for causing rotation of the lever arm 42 and the power screw 40. The power screw 40 multiplies the force output of the pneumatic piston and cylinder to levels necessary for stopping a train while using air cylinders designed for automotive applications. In the embodiment described here, the pitch of the power screw and normal positioning of the pads are such that the power screw will not rotate more than about one-half turn to fully apply the brakes.

A slack adjuster mechanism 50 between the lever arm 42 and power screw 40 adjusts the angular orientation between the lever arm 42 and power screw 40 as the brake shoes wear. The slack adjuster permits relative angular movement between the lever arm 42 and the power screw 40 only when the lever arm is returning to its near normal starting position, thus taking up slack that has developed as a result of the wear of the brake pads. In this way, the braking response does not change significantly as the pads wear.

According to a preferred embodiment of this invention, the slack adjuster is provided in a chamber in the lever arm that has the worm of a worm gear journaled therein. The worm gear pinion is fixed to the power screw between the right- and left-hand threads. Worm gears have the property of having a large gear ratio resulting in a large force amplification going from the pinion to the worm. Also, while it is easy for the worm to turn the pinion, the opposite is not the case. These properties are especially useful in this application making it possible to use less powerful pneumatic cylinders and piston combinations. Moreover, during brake applications resulting from rotation of the lever arm to spread the ends of the tongs, the worm must not turn in a direction to reduce the spread of the tongs.

Slack adjusters based upon worm gears are known in the brake art but, so far as known to the inventors, not in caliper-type disc brakes with pivoted tongs straddling the brake disc. A mechanism for driving the worm to take up slack includes apparatus for allowing the worm to turn only in the direction to take up slack and a clutch for disengaging the driving mechanism upon retraction of the brake pads. In some cases, the drive mechanism includes a rack for driving a pinion fixed to rotate the worm to take up slack. The rack is displaced by a lever or other connection that is responsive to the position of the lever or connection relative to the brake pad. The slack adjuster allows the piston to return to the same position relative to the cylinder as the brake pads wear while maintaining the same piston stroke to engage the brake pads. See, for example, U.S. Pat. No. 3,507,369 entitled “Adjuster for Cam Brake.” Worm gear slack adjusters are available commercially of the Euclid/Haldex type and Crewson Brenner type from Euclid Industries, L.L.C. an ArvinMeritor, Inc. company.

Having thus defined our invention in the detail and particularity required by the Patent Laws, what is desired protected by Letters Patent is set forth in the following claims.

The invention claimed is:

1. A disc brake caliper assembly for moving brake pads against each side of a brake disc, said assembly comprising: two tongs pivotably supported, said tongs having brake pads at one end and power nut support pins journaled at the other end, said tongs straddling the brake disc;
power nuts pivotally supported from the power nut support pins, said power nuts having internal threads, there being right-hand threads in one power nut and left-hand threads in the other power nut; and
a power screw extending between the tongs and having external threaded ends threaded in the power nuts,
such that rotation of the power screw will force the power nuts apart thus causing the brake pads to engage the brake disc.

2. A disc brake caliper assembly for moving brake pads against each side of a brake disc fixed relative to the axle of a wheeled vehicle, said axle being journaled in a structure supporting the wheels and axle and the vehicle chassis, said assembly comprising:
a frame supporting two spaced parallel journaled tong pins;
two tongs pivotably supported from the frame by respective tong pins, said tongs having brake head pins journaled at one end and power nut support pins journaled at the other end, said tongs straddling the brake disc;
brake heads and pads pivotally supported from the brake head pins, said pads having a friction face adjacent the brake disc;
power nuts pivotally supported from the power nut support pins, said power nuts having internal threads, there being right-hand threads in one power nut and left-hand threads in the other power nut;
a power screw extending between the tongs and having external threaded ends threaded in the power nuts;
a lever arm operatively attached to the power screw for rotating of the power screw;
a pneumatic cylinder and piston positioned between the frame and lever arm for causing rotation of the lever arm and the power screw; and
a slack adjuster mechanism enabling the pneumatic cylinder and piston to return to the same retracted position as the brake shoes wear,
such that rotation of the lever arm in one direction will cause a rotation of the power screw to force the power nuts apart thus causing the brake pads to engage the brake disc.

3. A disc brake caliper assembly for moving brake pads against each side of a brake disc fixed relative to the axle of a wheeled vehicle, said axle being journaled in a structure supporting the wheels and axle and the vehicle chassis, said assembly comprising:
a fixed hinge plate for being mounted to the supporting structure having a journaled hinge pin with an axis lying in a plane embraced by the brake disc;
a frame pivotably supported from the hinge plate by the journaled hinge pin, said frame supporting two spaced parallel journaled tong pins having axes lying in a plane perpendicular to the journaled hinge pin;
two tongs pivotably supported from the frame by respective tong pins, said tongs being symmetrical and having brake head pins journaled at one end and power nut support pins journaled at the other end, said tongs straddling the brake disc, said tong pins, brake head pins, and power nut pins being substantially parallel;
brake heads and pads pivotally supported from the brake pins, said pads having a friction face adjacent the brake disc;
power nuts pivotally supported from the power nut support pins, said power nuts having internal threads, there being right-hand threads in one power nut and left-hand threads in the other power nut;
a power screw extending generally perpendicular to the tongs and having external threaded ends threaded in the power nuts;
a lever arm operatively attached to the power screw for rotating of the power screw;
a pneumatic cylinder and piston positioned between the frame and lever arm for causing rotation of the lever arm and the power screw; and
a slack adjuster mechanism between the lever arm and power screw for adjusting the angular orientation between the lever arm and power screw as the brake shoes wear,
such that rotation of the lever arm in one direction will cause a rotation of the power screw to force the power nuts apart thus causing the brake pads to engage the brake disc.

4. The disc brake caliper assembly according to claim 2 or 3, wherein the slack adjuster mechanism is of the worm gear type.
